(19) United States
(12) Patent Application Publication
(10) Pub. No.: US 2019/0248112 A1
(43) Pub. Date: Aug. 15, 2019

(54) Multi-Layer Structural Component, Method for the Production Thereof and Uses Thereof

(71) Applicants: Volker Denkmann, Kempen (DE); Andreas Siemen, Jüchen (DE); Frank Uhl, Ober-Flörsheim (DE)

(72) Inventors: Volker Denkmann, Kempen (DE); Andreas Siemen, Jüchen (DE); Frank Uhl, Ober-Flörsheim (DE)

(73) Assignees: Hydro Aluminium Rolled Products GmbH, Grevenbroich (DE); Röchling Automotive SE & Co. KG, Mannheim (DE)

(21) Appl. No.: 16/394,908

(22) Filed: Apr. 25, 2019

Related U.S. Application Data
(63) Continuation of application No. PCT/EP2017/076662, filed on Oct. 19, 2017.

(30) Foreign Application Priority Data
Oct. 25, 2016 (DE) 10 2016 012 691.4

(51) Int. Cl. B32B 15/14; B32B 3/04; B32B 3/26; B32B 3/28; B32B 15/20; B32B 37/18; B32B 15/04

(52) U.S. Cl. CPC B32B 15/14; B32B 3/04; B32B 3/266; B32B 15/043; B32B 15/20; B32B 37/18; B32B 3/28

(57) ABSTRACT

A multi-layered structural component having a layer structure comprising a plurality of layers arranged one atop the other in a stacking direction. The layer structure includes at least one fiber structure consisting of a fiber material and of a thermoplastic binding agent, and at least one aluminum layer made of aluminum or of an aluminum alloy. At least one aluminum layer of the layer structure has a stiffening structure and/or a recess. The disclosure further relates to a method for producing such a structural component and to uses therefor.

### CROSS-REFERENCE TO RELATED PATENT APPLICATIONS

This patent application is a continuation of PCT/EP2017/076662, filed Oct. 19, 2017, which claims priority to German Application No. 10 2016 012 691.4, filed Oct. 25, 2016, the entire teachings and disclosure of which are incorporated herein by reference thereto.

### FIELD

The invention relates to a multi-layer structural component with a layer structure comprising a plurality of layers arranged on top of one another in a stacking direction, the layer structure comprising at least one fibre layer of a fibre material and of a thermoplastic binder, and at least one aluminium layer of aluminium or of an aluminium alloy. The invention also relates to a method for producing such a structural component, and to uses of such a structural component.

### BACKGROUND

Particularly in the construction and production of vehicle bodies, various technical requirements and specifications have to be fulfilled which must be taken into account when choosing the materials for the bodywork. For example, the construction of an underbody area for a motor vehicle requires optimising in terms of noise emission, drag coefficient, stability and crash behaviour. In addition, the materials and components which are used should also weigh as little as possible, to thus be able to achieve an optimised fuel consumption, for example.

In the prior art, linings are used, for example, for underbody areas of motor vehicles, which linings consist of a simple single-piece construction of polypropylene with a glass fibre filling, to thus achieve a good sound insulation and an improved drag coefficient c_{w}. For this purpose, the prior art uses the following materials, for example: long fibre-reinforced thermoplastics (LFT), glass mat-reinforced thermoplastics (GMT) or LWRT materials.

These linings are used together with profiled sheet constructions which form the actual underbody of the motor vehicle and provide the necessary stiffness, a sufficiently good crash behaviour and the constructive connection points to the rest of the bodywork frame structure. In additional working steps, floor constructions of this type are supplemented towards the interior by a plurality of layers of material having acoustic, optical and haptic functions.

However, these combined systems consisting of fibre composite lining, profiled sheet construction and additional floor layers require a considerable assembly effort. Furthermore, due to the relatively heavy profiled sheet constructions, many of these systems also need to be optimised in respect of their weight.

EP 2 965 902 B1 discloses a multi-layer structural component having a layer structure comprising a plurality of layers arranged on top of one another in a stacking direction, the layer structure comprising at least one fibre layer of a fibre material and of a thermoplastic binder, and at least one aluminium layer of aluminium or of an aluminium alloy, and the structural component having a connection element, embedded between two layers and partly projecting out of the layer structure, for joining the structural component to a further component. As a result, a component is provided which has good mechanical characteristics, such as bending stiffness, torsional stiffness and compressive strength with a relatively low weight, and which can be easily joined to a further component.

Structural components of this type are used, for example, in the vehicle underbody area. To optimise the stiffness of these structural components in respect of bending, torsion and pressure, and in respect of the crash behaviour, force-absorbing support structures of aluminium are integrated into the components.

Although these support structures fullfill the requirement of increasing stiffness, they are quiet complex to produce in separate working steps. Different profile shapes have to be produced, cut to length, welded, piece-pretreated and piece-bond painted before they can be processed together with fibre mats and metal intermediate layers into a finished multifunctional structural component.

Due to this expensive production process the costs of producing structural components of this type are very high.

### BRIEF SUMMARY

In view of the above, the object of the present invention is to provide a more economical structural component, a more economical method for the production thereof and a use for the structural component.

In the case of a multi-layer structural component with a layer structure comprising a plurality of layers arranged on top of one another in a stacking direction, the layer structure comprising at least one fibre layer of a fibre material and of a thermoplastic binder, and at least one aluminium layer of aluminium or of an aluminium alloy, this object is achieved according to the invention in that at least one aluminium layer of the layer structure has a reinforcing structure and/or a cutout. The reinforcing structure or the cutout is preferably a reinforcing structure produced by punching and/or forming, in particular by flanging, or a cutout. The reinforcing structure is preferably formed as a flanged edge (also called a flanged rim), a reinforcing bead or a cavity.

Within the scope of the invention, it has been found that generic structural components which, so far, had to be reinforced with profile structures and support structures to improve the mechanical characteristics can be produced more simply and more economically by using one or more aluminium layers having reinforcing structures, in particular flanged edges, reinforcing beads or cavities, and/or cutouts.

In this way, instead of profile structures and support structures, it is possible to use in particular correspondingly punched aluminium sheets (aluminium punching sheets) and/or formed aluminium sheets (flanged aluminium sheets, preferably flanged punched aluminium sheets) for the one or more aluminium layers of the structural component which can be produced in a simple and cost-effective manner. The aluminium sheets are preferably pre-coated, for example by a coil coating method. Embedding the aluminium sheets into the layer structure of the structural component also achieves a flat and thus improved fixing of the stiffness-increasing sheet to the other components of the structural component.

This method is particularly suitable for automobile manufacture in which, for example for the bodywork, other formed parts having punch-outs are also used to produce lightweight and rigid bodywork components. The process technology of punching and flanging is therefore already used in automobile manufacture and so the method described herein can be easily integrated into the existing production method.

Pre-coated, adhesively bonded and/or welded formed parts of aluminium sheet are preferably used for the one or more aluminium layers.

The layer structure comprises a plurality of layers arranged on top of one another in a stacking direction, the layer structure comprising at least one fibre layer of a fibre material and of a thermoplastic binder, and at least one aluminium layer of aluminium or of an aluminium alloy. In principle, the layer structure can comprise any number of superimposed layers. However, the layer structure preferably has at least two fibre layers and at least two aluminium layers.

The individual layers of the layer structure are preferably joined together in a firm and especially flat manner so that they form a firmly cohesive structural component. The layers are preferably integrally bonded together.

In the stacking direction, the layer structure preferably has a symmetrical structure. A symmetrical structure of the layer structure can prevent the structural component twisting, for example during changes in temperature.

At least one aluminium layer of the layer structure has a reinforcing structure, in particular a flanged edge, a reinforcing bead and/or a cavity, and/or a cutout. The layer structure can of course also have a plurality of aluminium layers with a reinforcing structure and/or a cutout.

The provision of reinforcing structures, in particular flanges, reinforcing beads and/or cavities improves the stiffness of the one or more aluminium layers, as a result of which it is possible to achieve a high bending and torsional stiffness and a high compressive strength. The crash behaviour of such structural components has also proved to be good. The aluminium layer preferably has a plurality of reinforcing structures, in particular a plurality of flanged edges, a plurality of reinforcing beads and/or a plurality of cavities to enhance the reinforcing effect. The number, arrangement and/or orientation of the flanged edges, reinforcing beads or cavities are preferably adapted to the intended purpose of use of the structural component.

A reinforcing bead is understood as meaning a bead in the material which is introduced in order to increase the stiffness, in particular the bending and torsional stiffness and compressive strength of the aluminium layer (or of the aluminium sheet used for this purpose) and thus of the structural component to be produced therefrom. A reinforcing bead of this type has in particular an extension direction, the length of which is greater, preferably many times greater than the width of the reinforcing bead. The width of the reinforcing bead is preferably at least 1 cm, in particular at least 3 cm. The length of the reinforcing bead is preferably at least double the size, in particular at least five times the width of the reinforcing bead.

A cutout is understood as meaning an opening in the aluminium layer or in the aluminium sheet. The cutout is preferably a punch-out, produced by punching.

To be distinguished from reinforcing beads are other deformations of the aluminium layer, for example cup-embossings which serve, for example as a material reservoir to improve the formability, but which do not cause an increase in stiffness.

The provision of cutouts can reduce the weight of the structural component. It has been found that the demands imposed in respect of stiffness on structural components of this type often do not require the aluminium layer or layers to be uniform. In fact, cutouts which reduce the weight can be provided particularly in less stressed areas.

At the same time, the structural components described here have a good corrosion resistance due to their materials and structure.

The above-mentioned object is also achieved according to the invention by a method for producing such a structural component wherein the layers of the layer structure are arranged one on top of another in a stacking direction in a forming tool and wherein the layers are hot-pressed to form a structural component.

Hot pressing is understood as meaning that the layers of the layer structure are heated before or during pressing such that the thermoplastic binder of the fibre layers softens. The layers of the layer structure are joined together in this way so that, after the binder has cured, they are joined firmly together and they form a cohesive structural component. Hot pressing is preferably carried out within a temperature range of from 170° C. to 230° C. The layer structure is preferably pressed over substantially the entire surface.

In the method, for at least one aluminium layer of the layer structure, an aluminium sheet having a reinforcing structure, in particular a flanged edge and/or a reinforcing bead, and/or having a cutout is preferably arranged in the forming tool. An aluminium sheet structure having a plurality of joined aluminium sheets can also be arranged in the forming tool for at least one aluminium layer of the layer structure, in which case at least one aluminium sheet of the aluminium sheet structure has a reinforcing structure and/or a cutout, or a cavity is provided between two aluminium sheets of the aluminium sheet structure.

Furthermore, the previously mentioned object is achieved according to the invention through the use of the previously described structural component as a construction element in automobile manufacture, in rail vehicle construction, in shipbuilding, in mechanical engineering, in aircraft construction or in the building sector.

In automobile manufacture, the previously described structural components can be used as a floor panel or as a front wall for example, and also as partition walls, loading floors and roof structures. In particular, for this purpose it is also possible to introduce cross members into the structural components, for example in order to install seat rails. If the vehicle to be produced does not have a tunnel area, the structural components which are used as a submodule can be formed to be very flat. For vehicles which have a tunnel area, a plastics tunnel can be connected to two submodules, the submodules consisting of one structural component.

In the rail sector, the structural components can be used in particular as floor panels or for wall and roof structures of rail vehicles. In aircraft construction and shipbuilding, the structural components can also be used for floor or wall and roof structures.

In mechanical engineering, the structural components can be used in particular as, or for machine housings for noise reduction.

In the building sector, the structural components can be used, for example, as elements for flood defence, as decorative wall elements or for soundproof walls.

The structural component is preferably configured for one of the previously mentioned uses. For example, the structural component can be formed as a motor vehicle underbody or as a part thereof.

Several embodiments of the structural component and of the method for the production thereof are described in the following, the individual embodiments respectively applying to the structural component and to the method for the production thereof. The embodiments can also be combined with one another.

In one embodiment of the structural component, the reinforcing structure (in particular the flanged edge, the reinforcing bead and/or the cavity) or the cutout in the aluminium layer is embedded between two fibre layers. The reinforcing structure (in particular the flanged edge, the reinforcing bead or the cavity) and/or the cutout are thus arranged inside the structural component. In particular, the respective aluminium layer is an inner layer which is arranged between two fibre layers. In a corresponding embodiment of the method, the reinforcing structure (in particular the flanged edge, the reinforcing bead and/or the cavity) or the aluminium sheet having the cutout or the multi-layer aluminium sheet structure is embedded between two fibre layers such that the reinforcing structure or the cavity is embedded between the fibre layers. In this way, the structural component is stiffened internally.

In an embodiment of the method, the aluminium sheet or the aluminium sheets for the aluminium layer are produced by punching and/or forming a sheet or strip of aluminium, in particular a coated sheet or strip of aluminium. In a corresponding embodiment of the structural component, the aluminium layer having the reinforcing structure (in particular the flanged edge or the reinforcing bead) or the aluminium layer having the cutout has a punched and/or formed aluminium sheet, in particular a flanged punched aluminium sheet. It has been found that the aluminium sheets, used for reinforcing the structural component, having for example a flanged edge, a reinforcing bead or a cutout can be produced easily and economically by punching and/or forming from an aluminium sheet or even directly from the aluminium strip. Compared to the production of expensive support structures, a very economical production is thus achieved.

In another embodiment, the aluminium layer having the cavity comprises two superimposed, joined aluminium sheets, between which the cavity is formed. Thus, in this embodiment, the aluminium layer is formed by a multi-layer aluminium sheet structure. In a corresponding embodiment of the method, two superimposed, joined aluminium sheets are arranged in the forming tool for an aluminium layer of the layer structure, a cavity being formed between the two aluminium sheets. The individual aluminium sheets can form in particular local half-shell profiles, between which the corresponding cavity is produced when the aluminium sheets are joined together. The aluminium sheets are preferably punched and/or formed, so that a cavity forms between them. The aluminium sheets can be joined together, for example by welding or adhesive bonding. The cavity or cavities can be produced simply and economically by joining together two punched or formed aluminium sheets. At the same time, the provision of cavities of this type ensures a very good stiffness. Closed cross-sectional profiles can also be constituted inside the structural component in this way.

Instead of joining the two aluminium sheets together by welding or adhesive bonding, it is also possible to arrange fibre layers over part of the surface between the aluminium sheets so that they join together during hot pressing. Cavities then form between the two aluminium layers due to the partial fibre layer.

In another embodiment, the cavity in the aluminium layer runs between two openings, so that a line can be guided through the cavity, in particular an energy, media or signal line. A line, in particular an energy, media or signal line is preferably guided through the cavity from one opening to the other opening. For example, the cavity can run in a substantially straight manner between a first and a second opening, thereby producing a channel through which a line can be guided. In this way, the structural component can also be used for a concealed conduit, and the line is also protected by the stiffness of the structural component.

In a further embodiment, the aluminium layer having the reinforcing structure or the cutout has a thickness in a range of from 200 to 2000 μm. A sufficient stiffness of the aluminium layer is obtained by the lower limit of 200 μm. Thinner aluminium layers with similar deformations merely result (if at all) in a slight increase in stiffness. The producibility and the processibility of the structural components are improved by the upper limit of 2000 μm.

An aluminium layer of the structural component can protrude laterally over the fibre layers, so that the structural component can be connected to a frame construction, for example of a motor vehicle.

Furthermore, in another embodiment, it is possible to achieve a connectability of the composite component to such a frame construction in that the structural component comprises a connection element of metal, the connection element having an anchoring region which is embedded between two layers of the layer structure which are adjacent in the stacking direction, in particular between two fibre layers, and the connection element has a connection region, which is at least partly arranged outside the layer structure, to join the structural component to a further component.

In a further embodiment, the at least one aluminium layer of the layer structure is provided with an adhesion promoting layer, in particular with a PP, PA or polyester adhesion promoter. This measure improves and strengthens the join between the aluminium layer and the synthetic fibre composite layer.

To produce the structural component, a coated sheet or strip of aluminium is preferably used, in particular a sheet or strip of aluminium which has been coated with the previously described adhesion promoting layer. Coating is preferably carried out by a strip coating (coil coating) method, but it can also be performed, for example by dip coating or by spray coating, with a subsequent drying step.

The use of a coated aluminium strip, in particular a coil-coated aluminium strip provides a more cost-effective production compared to the use of support structures which have to be piece-coated.

In a further embodiment, the at least one fibre layer at least in some sections has respectively a porosity of at least 75%. The porosity of a material is understood as meaning the ratio of the cavity volume to the total volume of the material. Apart from the low weight, an advantage of the porosity of the fibre layers is the fact that these layers have a sound insulating effect and thus it is possible to dispense with an additional sound insulation of the structural component.

During the production of the structural component, in particular by the previously described method, the individual layers of the layer arrangement are usually hot pressed.

During hot pressing, the structural component can be compacted in some sections and in the compacted or partly compacted sections, the porosity of the fibre layers can also be less than 75%, provided that the fibre layers in the finished structural component have, at least in some sections, preferably for the most part, a porosity of at least 75%.

For example, in the case of a fibre layer with a surface weight of approximately 500 g/m² and having a glass fibre proportion of approximately 40 mass percent and a polypropylene proportion of approximately 60 mass percent as thermoplastic binder, it is possible to achieve a complete compacting (in the respective compacted sections) (porosity of approximately zero) when the fibre layer is pressed to a thickness of approximately 0.4 mm, a porosity of approximately 50 percent when pressed to 0.8 mm, a porosity of approximately 75 percent when pressed to 1.6 mm and a porosity of approximately 87.5 percent when pressed to 3.2 mm.

For sound insulation and weight reasons, it is preferable for at least one fibre layer to have a porosity of between 85% and 95% at least in some sections, preferably predominantly or completely, and preferably a plurality of fibre layers or all the fibre layers have the above-mentioned porosity at least in some sections.

In order to be able to use the sound-insulating properties of the fibre layer more effectively, it can be provided that at least one aluminium layer which is in the furthest outlying position in the stacking direction, has a micro-perforation. It is preferable for both furthest outlying aluminium layers in the stacking direction to have this micro-perforation. In this way, sound waves can be conducted through the micro-perforated aluminium layer into the adjacent fibre layer, where they are then absorbed to a significant extent.

A middle aluminium layer of the layer structure, in other words an aluminium layer which is not the furthest outlying layer is preferably formed as a closed layer to ensure a water tightness of the structural component. A layer of this type in particular does not have a micro-perforation.

In a further embodiment, in addition to aluminium layers and fibre layers, the layer structure also comprises one or more layers consisting of other materials and/or having a different structure, in particular as the outer layer (cover layer). In this way, it is possible to adjust the characteristics of the structural component in particular to the surface, as required.

For example, the layer structure can have a cover layer of a porous material, such as a fibrous web or a foam mat which is firmly joined to at least one of the other layers of the layer structure. The layer structure can have in particular a cover layer of textile material, for example in the manner of a carpet.

If the structural component is formed as a motor vehicle floor, then it is possible, for example, to provide a stone impact-resistant fibrous web material on an outer side, facing the road in the installed state, of the structural component and a carpet or a decorative layer on the outer side facing the passenger compartment. In this way, a structural component is provided which can be directly used as the underbody of a motor vehicle, for example, without further layers having to be subsequently applied on the structural component.

The layer structure can also have as the cover layer a painted metal layer or a decorative layer which is joined to at least one layer of the layer structure. Furthermore, as protection against corrosion, the layer structure can also have a plastics layer as the cover layer or it can be surrounded by such a layer.

By adapting the number and thicknesses of the aluminium layers and/or of the fibre layers, the fibre material content in the fibre layers, the type of micro-perforation of the aluminium layers and the choice of the outer layers (for example carpet, acoustic fleece, decoratively painted aluminium, etc.), different functionalities of the structural component can be adjusted as required, in particular in respect of the weight, the bending and torsional stiffness and compressive strength, the crash behaviour, corrosion stability, acoustic efficiency, heat insulation, optical appearance and a low c_{w} value.

In principle, the structural component can be formed as a flat panel. However, it is preferably formed in three dimensions, for example to increase the bending stiffness of the component in particular directions or to adapt the shape of the component to the surroundings (for example to the body of a motor vehicle) into which the component is to be introduced. For this purpose, the stacked layers can be pressed under pressure and, if appropriate, under the effect of heat and can be brought into the desired three-dimensional form.

In an embodiment of the method, at least one fibre layer of the layer structure is arranged in the forming tool as a fibre mat, the fibre mat comprising inorganic fibres and fibres of thermoplastic. When the fibre mat is hot-pressed, the fibres of thermoplastic melt at least partly or substantially completely and they form a plastics melt. When the plastics melt re-solidifies, for example during or after the hot pressing of the fibre mat, a cohesive fibre layer is then produced. The fibres of thermoplastic thus serve as a thermoplastic binder which softens when the layer is hot-pressed and binds the inorganic fibres. In this way, a layer is produced which has a low density but a high stability.

The fibre mat preferably substantially consists, in particular to at least 80%, preferably to at least 95%, of inorganic fibres and of fibres of thermoplastic. For example, the fibre mat can comprise a mixture of polypropylene fibres and glass fibres.

The fibre mat can be prepared, for example, in that first of all a fibre mat of fibres of thermoplastic is prepared, onto which inorganic fibres, such as glass fibres, are then applied. The inorganic fibres can then be mixed with the fibres of thermoplastic, for example by mechanically working the inorganic fibres into the fibre mat. After the thermoplastic fibres and the inorganic fibres have been mixed together, the fibre mat can optionally be homogenised and processed, for example woven, into a fibrous web. A fibrous web of this type can have a thickness of from 50 to 80 mm, for example. The fibre mat can be homogenised in particular by fulling and/or needling the fibrous web.

The fibre mat can also be initially hot-pressed in a separate tool and then arranged in the forming tool as a pre-pressed fibre layer.

In a further embodiment of the method, the structural component is heated after hot pressing, such that the thickness of at least one fibre layer increases at least in some sections.

In the fibre layer, at least some of the fibres are not completely stretched, but they are at least partly crooked, so that these crooked fibres are under tension in the fibre layer. During heating after hot pressing, some of the thermoplastic binder softens or melts so that the crooked fibres straighten again, small cavities forming in the fibre layer and in this way, the thickness of the fibre layer increases, as does the porosity thereof.

Fibre layers of this type are distinguished on the one hand by good strength characteristics with a relatively low weight, and on the other hand by good acoustic characteristics, in particular good sound-insulating characteristics. Furthermore, the characteristics of fibre layers of this type can be specifically adjusted during production, so that in this way, it is possible to adjust the material characteristics which are required for a specific use.

A further embodiment of the method is characterised in that the layers of the layer structure are arranged in an unpressed state in the forming tool, in that the layers in the forming tool are hot pressed to form a structural component, the structural component having a relatively small thickness at least in some regions based on the intended shape of the structural component, in that the forming tool is adjusted to the intended shape of the structural component to be produced and in that the structural component is heated in the forming tool such that the structural component assumes the intended shape of the structural component by increasing the thickness at least in some sections of at least one fibre layer.

In this way, the structural component can be produced in one process cycle and in one forming tool, meaning that the production of the structural component is simplified and rationalised. In particular, in this embodiment it is possible to economise on tools for pre-pressing fibre layers.

In another embodiment of the method, the aluminium layers are arranged in the forming tool as sheets of aluminium or of an aluminium alloy. The aluminium sheets can be provided, for example by rolling an aluminium strip and cutting the aluminium strip to size to produce aluminium sheets. Where there is a plurality of aluminium layers, the layers can consist of the same or different aluminium alloys. Furthermore, one or more of the aluminium layers can be prefabricated and/or pre-formed in a press, in particular subject to the desired form of the structural component. One or more aluminium layers can also be fed in strip-form to the forming tool, for example to a double-belt press, and can be arranged therein. In this way, it is also possible to produce the structural components in strip-form.

Further features and advantages of the present invention will emerge from the following description of embodiments, reference being made to the accompanying drawings.

### BRIEF DESCRIPTION OF THE DRAWINGS

FIGS. 1a-d show a method for producing a structural component from the prior art;

FIG. 2 shows a support structure, as used for structural components from the prior art;

FIGS. 3a-e show an embodiment of the method according to the invention for producing a structural component;

FIGS. 4a-c show a strip or sheet of aluminium during the implementation of the method from FIG. 3a-e;

FIG. 5 shows an embodiment of the structural component according to the invention;

FIG. 6a-c show an aluminium sheet for further embodiments of the method for producing a structural component or the structural component; and

FIG. 7a-c show a further embodiment of the method for producing a structural component or the structural component.

### DETAILED DESCRIPTION

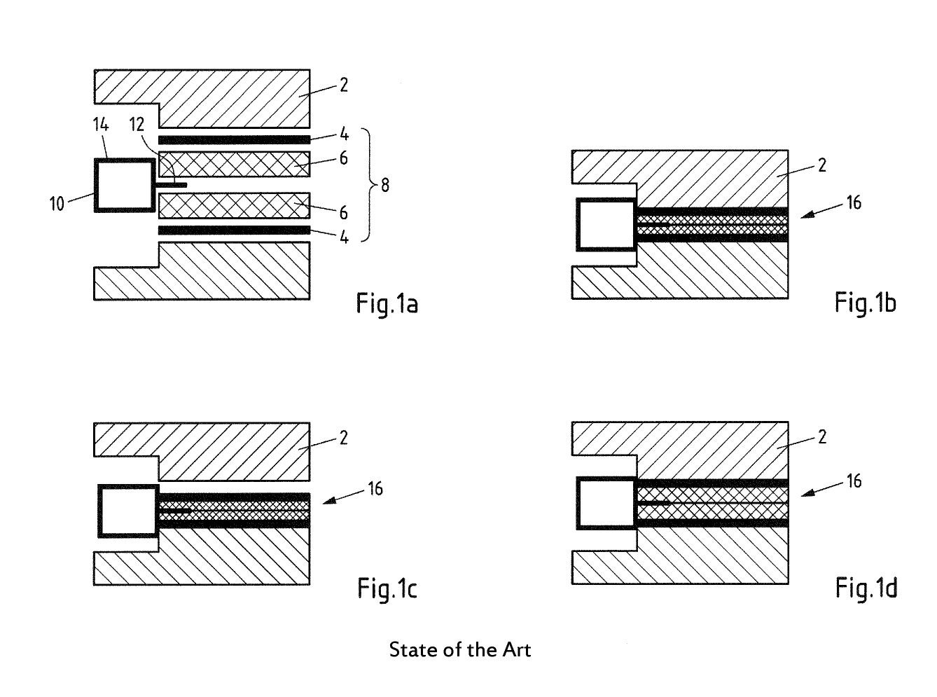

FIG. 1a-d show a method for producing a structural component from the prior art.

In the first step shown in FIG. 1a, two aluminium layers 4 of an aluminium alloy, and two fibre layers 6 of a fibre material and of a thermoplastic binder are arranged one above another in a stacking direction in a forming tool 2 configured as a press, to form a layer structure 8. A connection element 10 is also arranged such that a tab-like anchoring region 12 of the connection element 10 is embedded between two fibre layers 6, which are adjacent in the stacking direction, of the layer structure 8. In addition to the anchoring region 12, the connection element 10 also has a connection region 14 which has the form of a hollow profile and is arranged outside the layer structure 8.

In this embodiment, in the first step the fibre layers 6 are present in the form of a fibre mat of inorganic fibres, for example glass fibres and fibres of a thermoplastic, such as polypropylene. Here, the thermoplastic fibres assume the function of the thermoplastic binder. In an alternative embodiment, the fibre layers 6 can also be arranged in the forming tool 2 in the form of pre-pressed fibre mat.

The aluminium layers 4 are respectively provided with an adhesion promoting layer on the side facing the adjacent fibre layer 6 to improve the adhesion between the aluminium layer 4 and the fibre layer 6. The connection element 10 is also provided with an adhesion promoting layer in the anchoring region 12 to increase the adhesion between the connection element 10 and the two surrounding fibre layers 6. The adhesion promoter can be, for example, a PP or PE adhesion promoter.

In the second step of the method shown in FIG. 1b, the layers of the layer structure 8 and the embedded anchoring region 12 of the connection element 10 are hot pressed in the forming tool 2. During hot pressing, the temperature in the fibre layers 6 is increased to a value above the softening temperature of the thermoplastic fibres, so that they melt at least to some extent. Furthermore, the forming tool presses the layer structure 8 together with the embedded anchoring region 12, so that when the thermoplastic hardens, the individual layers of the layer structure 8 and the anchoring region 12 are joined firmly together and produce a multi-layer structural component 16. The forming tool 2 is configured in the region of the connection region 14 of the connection element 10 such that the connection region is not also pressed. In addition, in this step of the method, the forming tool 2 is set up so that it presses the layer structure 8 into a shape which has a smaller thickness at least in some regions than the intended shape of the structural component 16.

In the third step shown in FIG. 1c, after hot pressing, the forming tool is adjusted to the intended shape of the structural component 16. The structural component 16 is then re-heated to a value above the softening temperature of the thermoplastic of the fibre layers. As a result of this heating procedure, the thermoplastic binder in the fibre layers 6 melts again at least to some extent, so that the inorganic fibres in these layers can be re-aligned. In doing so, cavities appear in the fibre layers 6 so that the fibre layers 6 expand in thickness until they have assumed the intended shape which is preset by the forming tool 2, as shown in FIG. 1d.

During the expansion of the fibre layers 6, the porosity of these layers simultaneously increases, so that the specific density of the structural component 16 is reduced. Finally, after the thermoplastic in the fibre layers 6 has re-hardened, the finished structural component 16 can be removed from the forming tool and used as intended.

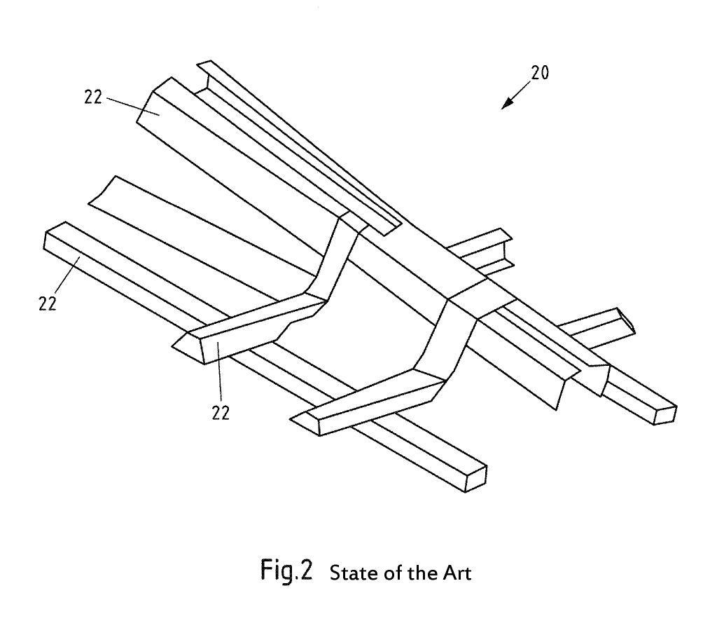

To provide the prior art structural component 16 with the requisite stiffness, it was necessary in the prior art to embed support structures in the structural component 16 or to join support structures to the structural component. FIG. 2 shows a support structure 20 of this type from the prior art which has a plurality of welded-together profiles 22. In the prior art, such support structures were embedded in particular into the structural components 16, in that they were embedded in the layer structure 8 between two fibre layers 6 in the first step which is shown in FIGS. 1a and 1s described above.

Apart from the increased effort due to welding the profiles 22 to form the support structure 20, this method also requires a single piece pretreatment (for example to improve the corrosion protection) and a single piece precoating of the support structure 20 with adhesion promoter in order to ensure a sufficient join with the fibre layers 6 during the pressing procedure.

It has now been found that a simpler and more economical method for producing structural components of a high stiffness can be obtained by replacing the support structure 20 in the structural component 16 with preferably pre-painted, optionally adhesively bonded or welded, single-layer or multi-layer aluminium sheet formed parts.

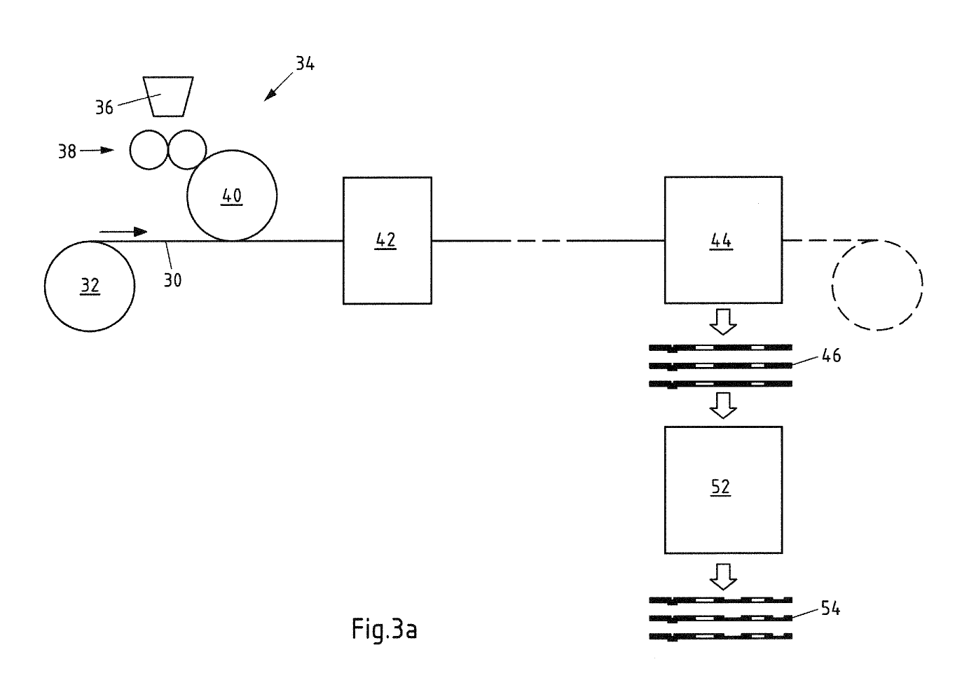

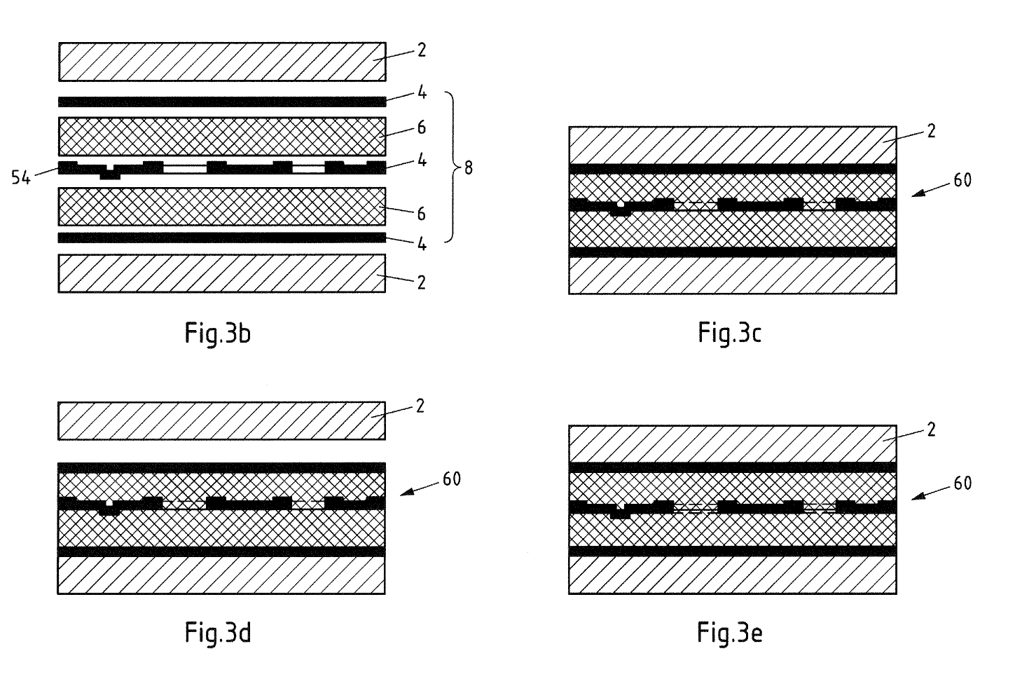

FIG. 3a-e show an embodiment of the method according to the invention for producing a structural component. In the method, to begin with, an aluminium strip 30 is unwound from a coil 32 and is coated by a strip coating (coil coating) device 34, whereby an adhesion promoter, for example a PP, PA or polyester adhesion promoter is applied uniformly over the surface of the strip 30 from a reservoir 36 via metering rollers 38 and an application roller 40. The applied adhesion promoting layer is then dried in a drying channel 42.

FIG. 3a shows a unilateral coil coating procedure; however, bilateral coil coating is also possible.

Furthermore, before the coil coating procedure, the aluminium strip 30 can also be pretreated, for example by applying a corrosion protection layer or a passivation layer.

Thereafter, the coated strip 30 is delivered, directly or after being temporarily rolled up into a coil and unrolled again therefrom, to a punching device 44 in which punched aluminium sheets 46 are punched out of the strip 30. Alternatively, the strip 30 can also be firstly cut into individual aluminium sheets which are then fed to the punching device 44 so that the punched aluminium sheets 46 can be punched therefrom. The punching waste can be delivered to a recycling system, in particular it can be melted down.

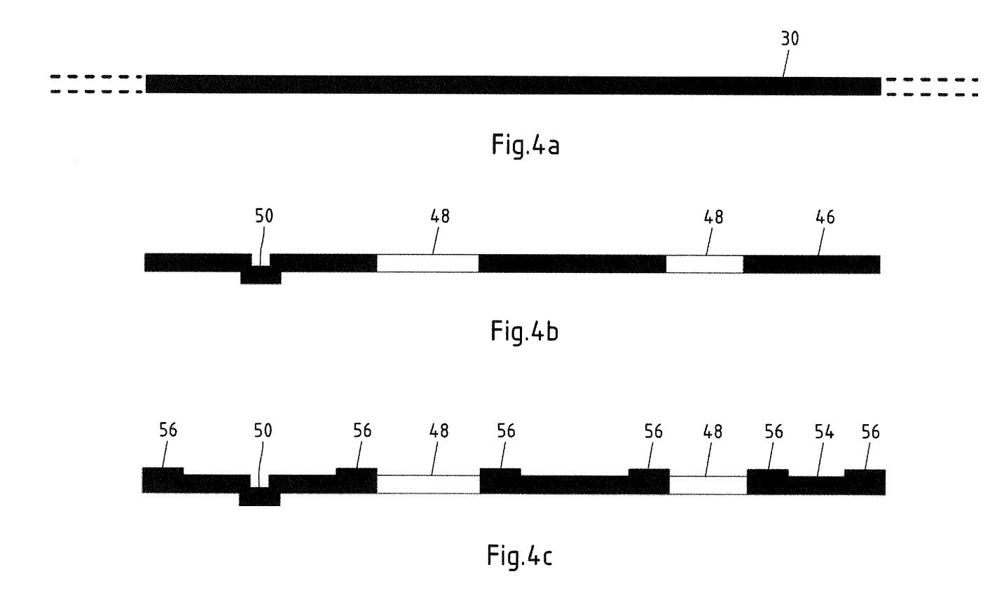

FIG. 4a is a cross-sectional view of the coated strip 30 (or alternatively sheet) before the punching-out process. FIG. 4b shows the punched-out aluminium sheet 46. The punching-out process establishes the outer shape of the punched aluminium sheet 46. Furthermore, cutouts 48 and reinforcing beads 50 are punched into the punched aluminium sheet 46. The cutouts 48 serve to reduce weight and can be punched into the punched aluminium sheet 46 in places where there are lower stiffness requirements for the purpose of use of the finished structural component. In contrast thereto, the reinforcing beads 50 are punched into the punched aluminium sheet 46 in places where there are higher stiffness requirements for the purpose of use of the finished structural component. In this way, the stiffness of the structural component to be produced can be specifically adapted to the intended stiffness requirements, while simultaneously optimising the weight. For example, the stiffness of the finished structural component can be specifically increased at force introduction points by the reinforcing beads 50.

After the punching process, the punched aluminium sheets 46 are fed to a flanging device 52 in which edges of the punched aluminium sheet 46 are flanged. The flanged punched aluminium sheet 54 is shown in cross section in FIG. 4c. The flanged punched aluminium sheet 54 is flanged at the outer edges and at the edges of the cutouts 48, and it presents corresponding flanged edges 56 which are schematically shown as thickenings in FIG. 4c.

The coated and flanged punched aluminium sheets 54 can then be further used to produce the structural component.

The further steps of the production method shown in FIGS. 3b to 3e are similar to the steps, shown in FIG. 1a to 1d, of the previously described method from the prior art, to which reference is made here. Components which correspond to one another have been provided with the same reference numerals.

In the step shown in FIG. 3b, three aluminium layers 4 which are coated with adhesion promoter and consist of an aluminium alloy, and two fibre layers 6 of a fibre material and of a thermoplastic binder are arranged one above another in a stacking direction in a forming tool 2 configured as a press, to form a layer structure 8. The middle aluminium layer is formed by the previously produced, coated and flanged punched aluminium sheet 54. Alternatively, flanged punched aluminium sheets 54 can also be used for the outer aluminium layers. A different number of aluminium layers or a different number of fibre layers is also possible.

In FIG. 1a, a connection element 10 was also embedded in the layer structure 8. This is not provided in FIG. 3b, but alternatively it can likewise be embedded in the layer structure 8 in the method described in FIG. 3a-e.

In the step shown in FIG. 3c, the layers of the layer structure 8 are hot pressed analogously to FIG. 1b to form a structural component 60. In this step, the forming tool is set up so that it presses the layer structure 8 into a shape which has a smaller thickness, at least in some regions, than the intended shape of the structural component 60.

In the step shown in FIG. 3d, after hot pressing, the forming tool 2 is adjusted to the intended shape of the structural component 60 and the structural component 60 is re-heated to a value above the softening temperature of the thermoplastic of the fibre layers, so that the fibre layers 6 become enlarged, as described for FIG. 1c, until they have assumed the intended shape, preset by the forming tool 2, as shown in FIG. 3d.

Finally, after the thermoplastic in the fibre layers 6 has re-hardened, the finished structural component 60 can be removed from the forming tool and used as intended.

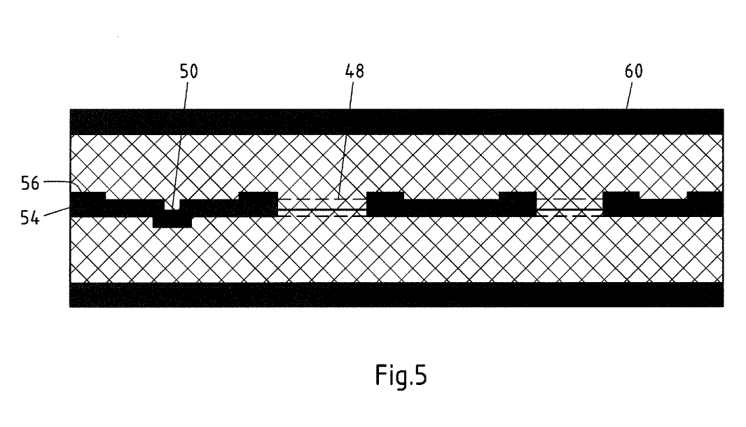

FIG. 5 is a cross-sectional view of the finished structural component 60. As a result of the hot pressing procedure, the individual layers of the structural component 60 are firmly joined together. Furthermore, the adhesion promoting layers ensure a firm bond.

The structural component 60 has good values for bending and torsional stiffness and for compressive strength in the regions of the reinforcing beads 50 and the flanged edges 56. Furthermore, the weight is reduced due to the cutouts 48 in the regions which have lower requirements in respect of stiffness.

The method, described with reference to FIG. 3a-e, for producing the structural component 60 does not require an expensive production of support structures or an expensive single-piece coating. Instead, method steps which can be carried out easily, quickly and economically, such as coil coating and punching-out and forming (in particular flanging) are used. As a result, the structural component 60 can be produced easily and economically, at the same time with a good stiffness and a low weight.

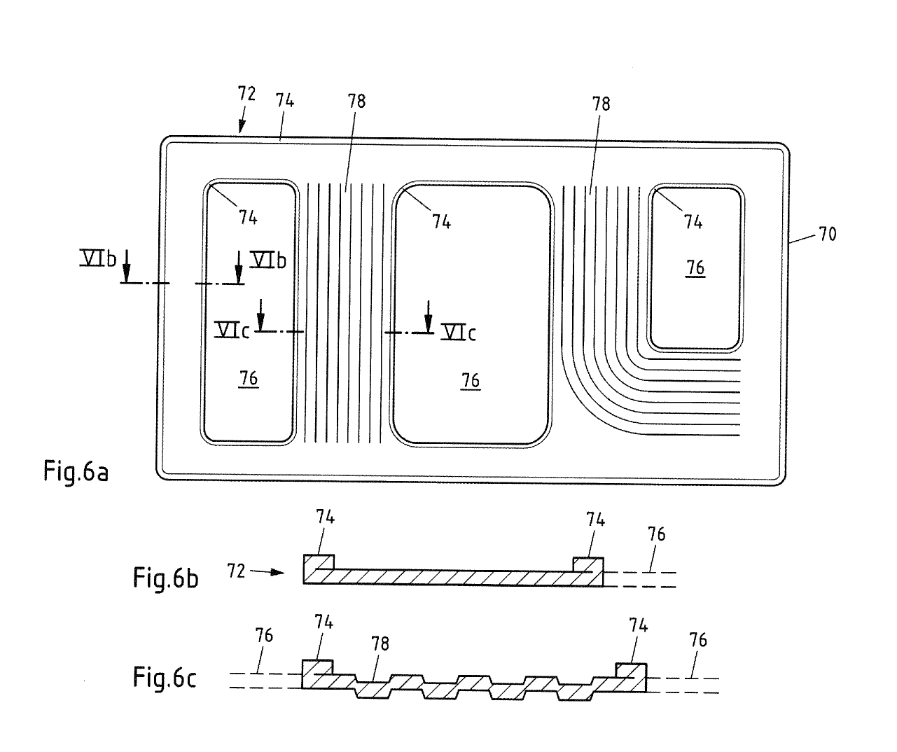

FIG. 6a-c show an embodiment for a flanged punched aluminium sheet 70 which can be produced in the method step previously described with reference to FIG. 3a. FIG. 6a is a plan view, and FIG. 6b-c are two partial cross-sectional views along the section lines marked by VIb and VIc in FIG. 6a.

The flanged punched aluminium sheet 70 has a flanged outer contour 72 with flanged edges 74 which increase the stiffness in the peripheral region. Furthermore, the punched aluminium sheet 70 has different cutouts 76, the purpose of which is to reduce weight. The edges of the cutouts 76 are also flanged to increase the stiffness and they have corresponding flanged edges 74. In addition, punched into the punched aluminium sheet 70 are reinforcing beads 78 which also cause an increase in stiffness in the corresponding regions. The number, size and course of the reinforcing beads 78 are preferably adapted to the stiffness requirement profile for the punched aluminium sheet 70 in the structural component to be produced therefrom.

In the steps shown in FIG. 3b-e, the flanged punched aluminium sheet 70 can then be used to produce a structural component 60 instead of the flanged punched aluminium sheet 54, or for another aluminium layer 4.

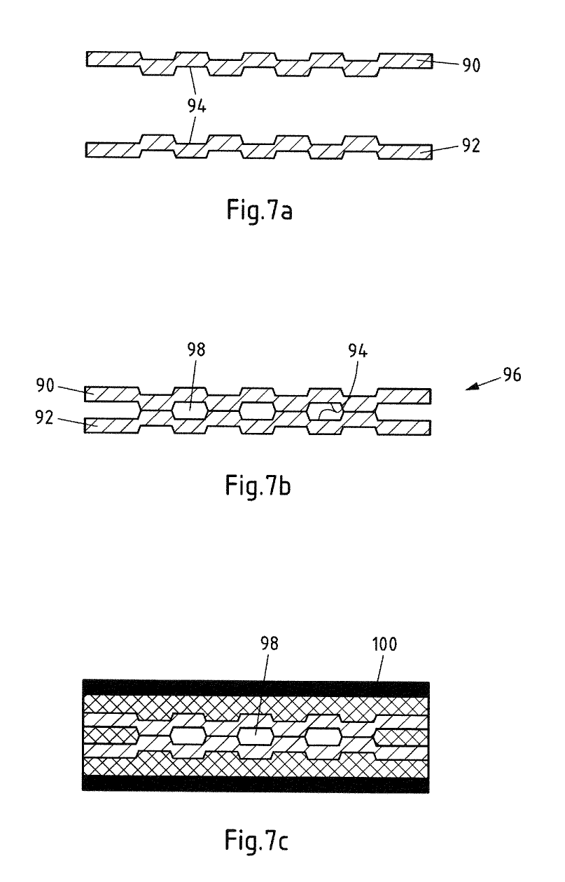

FIG. 7a-c show a further embodiment of the method for producing a structural component or the structural component.

In a first step, two punched aluminium sheets 90, 92 are produced with respective reinforcing beads 94, for example by a method step analogously to FIG. 3a.

The two punched aluminium sheets 90, 92 are then adhesively bonded or welded to form a two-layer aluminium sheet structure 96, so that cavities 98 appear between the punched aluminium sheets 90, 92. In particular, the reinforcing beads 94 produce a (multiple) half-shell shape of the punched aluminium sheets 90, 92, so that corresponding cavities 98 are formed as a result of the sheets being joined together.

The two-layer aluminium sheet structure 96 can then be further used to produce a structural component in the steps shown in FIG. 3b-e, instead of the flanged punched aluminium sheet 54, or for another aluminium layer 4. FIG. 7c shows a correspondingly produced structural component 100. The cavities 98 in the aluminium sheet structure 96 result in an increase in stiffness.

The cavities 98 are preferably channel-shaped and they run between two openings of the structural component 100. In this way, a channel is provided which can be used to conduct an energy, media or signal line.

Using the previously described method, it is possible for a multifunctional composite component to be produced which is optimised in terms of stiffness and which, if required, can even be used for cable conduction.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A multi-layer structural component, comprising:
a layer structure comprising a plurality of layers arranged on top of one another in a stacking direction,
the layer structure comprising at least one fibre layer of a fibre material and of a thermoplastic binder, and at least one aluminium layer of aluminium or of an aluminium alloy,
wherein at least one aluminium layer of the layer structure has a reinforcing structure where the reinforcing structure is formed as a flanged edge.

2. The structural component according to claim 1, wherein the aluminium layer of the layer structure has a cutout.

3. The structural component according to claim 1, wherein the reinforcing structure is further formed as a reinforcing bead or as a cavity.

4. The structural component according to claim 1, wherein the reinforcing structure, in particular the flanged edge, a reinforcing bead, a cavity, or a cutout of the aluminium layer is embedded between two fibre layers.

5. The structural component according to claim 1, wherein the aluminium layer having the reinforcing structure, in particular the flanged edge, a reinforcing bead, or a cutout, comprises a punched and/or formed aluminium sheet.

6. The structural component according to claim 3, wherein the aluminium layer having the cavity comprises two superimposed, joined aluminium sheets, between which the cavity is formed.

7. The structural component according to claim 3, wherein the cavity in the aluminium layer runs between two openings, so that a line can be guided through the cavity, in particular an energy, media or signal line.

8. The structural component according to claim 1, wherein the aluminium layer having the reinforcing structure or a cutout has a thickness in a range of from 200 to 2000 μm.

9. The structural component according to claim 1, wherein the structural component comprises a connection element of metal, the connection element having an anchoring region which is embedded between two layers of the layer structure which are adjacent in the stacking direction, in particular two fibre layers, and the connection element having a connection region which is at least partly arranged outside the layer structure, to join the structural component to a further component.

10. The structural component according to claim 1, wherein the at least one aluminium layer of the layer structure is provided with an adhesion promoting layer, in particular with a PP, PA or polyester adhesion promoter.

11. The structural component according to claim 1, wherein the at least one fibre layer at least in some sections has respectively a porosity of at least 75%.

12. A method for producing a structural component according to claim 1, comprising the steps of:
arranging the layers of the layer structure one on top of another in the stacking direction in a forming tool, and
hot pressing the layers to form a structural component.

13. The method according to claim 12, wherein for an aluminium layer of the layer structure, an aluminium sheet having a reinforcing structure, in particular the flanged edge or a reinforcing bead, and/or having a cutout is arranged in the forming tool.

14. The method according to claim 12, wherein for an aluminium layer of the layer structure, two superimposed, joined aluminium sheets are arranged in the forming tool, a cavity being formed between the two aluminium sheets.

15. The method according to claim 13, wherein the aluminium sheet or aluminium sheets for the aluminium layer are produced by punching and/or forming an aluminium sheet or aluminium strip, in particular a coated aluminium sheet or aluminium strip.

16. The method according to claim 12, wherein at least one fibre layer of the layer structure is arranged in the forming tool as a fibre mat, the fibre mat comprising inorganic fibres and fibres of thermoplastic.

17. The method according to claim 12, wherein after the step of hot pressing, the method further comprises the step of heating the structural component such that the thickness of at least one fibre layer increases at least in some sections.

18. The method according to claim 12, wherein
the layers of the layer structure are arranged—in the forming tool in an unpressed state,
the layers in the forming tool are hot-pressed to form a structural component, the structural component having a relatively small thickness at least in some sections relative to the intended shape of the structural component,
the forming tool is adjusted to the intended shape of the structural component to be produced, and
the structural component is heated in the forming tool such that the structural component assumes the intended shape of the structural component by increasing the thickness of at least one fibre layer at least in some sections.

19. Use of a structural component according to claim 1 as a construction element in automobile manufacture, rail vehicle construction, shipbuilding, mechanical engineering, aircraft construction or in the building sector.
